(19) United States
(12) Patent Application Publication
(10) Pub. No.: US 2007/0229944 A1
(43) Pub. Date: Oct. 4, 2007

(54) Reducing extreme ultraviolet flare in lithographic projection optics

(76) Inventors: Sang H. Lee, Sunnyvale, CA (US); Christof Krautschik, Cupertino, CA (US)

Correspondence Address: TROP PRUNER & HU, PC, 1616 S. VOSS ROAD, SUITE 750, HOUSTON, TX, 77057-2631, US

(21) Appl. No.: 11/395,669

(22) Filed: Mar. 31, 2006

(51) Int. Cl. F21V 9/04

(52) U.S. Cl. 359/359

(57) ABSTRACT

An extreme ultraviolet lithography system may have a spatial filtering system in projection optics that reduce flare. A flare filter may be provided at the pupil plane to pass the required diffraction orders (at minimum 0^{th} and +1 or 0^{th} and −1 orders) of the light from the mask, while blocking the effects of scattering from various mirrors used in the projection optics. By reducing flare, process window and critical dimension variation can be improved.

### BACKGROUND

This relates generally to projection optics used in lithography for fabricating integrated circuits by transferring patterns from a mask to the integrated circuit wafer.

In integrated fabrication, extreme ultraviolet radiation (EUV) may be utilized to expose a mask and to transfer a pattern on the mask to an integrated circuit wafer. The mask or grating may be exposed to the extreme ultraviolet radiation. The light from the mask or grating is focused by a projection optical system onto the wafer.

Flare may arise due to the surface scattering from the mirrors comprising the compound projection optic. The EUV lithographic projection optics include multilayer mirrors, and the extreme ultraviolet flare is due to mid-spatial frequency roughness of the mirror surfaces. The scattering from the mirror surfaces will be imaged as background DC light at the wafer plane. Flare can reduce process window and increase critical dimension variation across the field. However, due to the short scattering range of extreme ultraviolet wavelengths, the flare is essentially constant over the field, making its effect on critical dimensions and process window relative easy to predict and possibly correctable through mask design. Thus, flare is less likely a concern for extreme ultraviolet lithography as long as the amount of open frame flare is below ten percent. However, being proportional to one over the wavelength squared, flare in extreme ultraviolet systems can be difficult to control. Angular dependence of short range flare can lead to local critical dimension variations. It is also challenging to reduce the intrinsic flare or flare in open field below ten percent.

For any lithographic system, the diffraction pattern seen at the optic's exit pupil plane can be predicted if the mask patterns are known. For the perfect system or flare-free system, the exit pupil has diffraction patterns in certain areas of the pupil. Extreme ultraviolet mirrors have some amount of roughness and contribute to scattering at the pupil plane, which will eventually become background light at the wafer plane.

### BRIEF DESCRIPTION OF THE DRAWINGS

FIG. 1 is a depiction of an extreme ultraviolet lithography system in accordance with one embodiment of the present invention;

FIG. 2 is a side elevation of a projection optics for an extreme ultraviolet lithography system in accordance with one embodiment of the present invention;

FIG. 3 is a depiction of the pupil view for diffraction patterns of dense lines and spaces (or grating mask patterns) with scattering from rough mirror surfaces;

FIG. 4 is a depiction of a flare filter to block the scattering portion or unused portion of pupil in accordance with one embodiment of the present invention;

FIG. 5 is a depiction of the effect of the flare filter in accordance with one embodiment of the present invention;

FIG. 6 is a depiction of a frequency doubling flare filter which blocks 0^{th} order diffraction pattern in accordance with one embodiment of the present invention; and

FIG. 7 is a depiction of the effect of the flare filter shown in FIG. 6 in accordance with one embodiment of the present invention.

### DETAILED DESCRIPTION

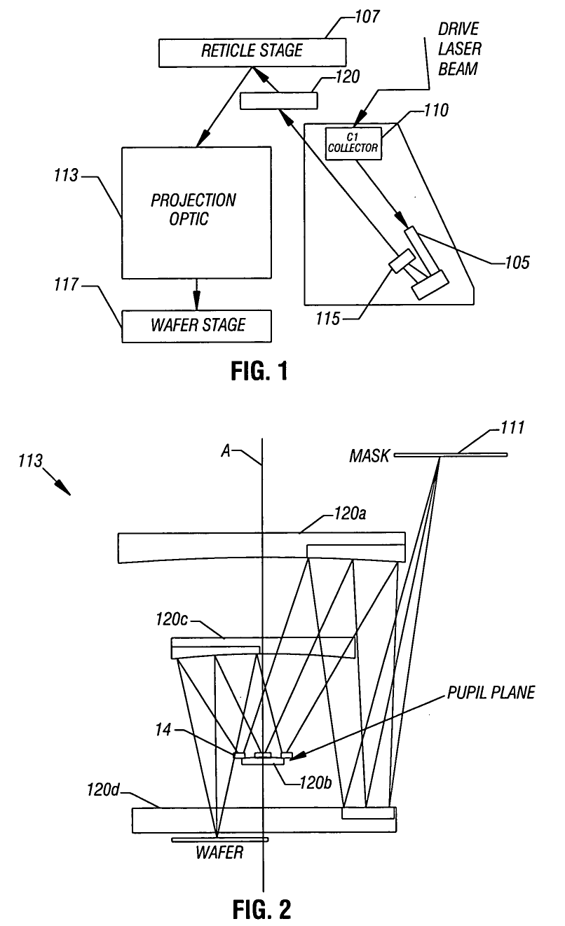

FIG. 1 shows an engineering test system (ETS) embodiment of an extreme ultraviolet (EUV) lithography system as an example EUV system. However, the present invention is not limited to the use of one type of system and is applicable to any EUV system.

The ETS system may include a drive laser beam which illuminates a C1 multilayer coated collector 110 in one embodiment. The collector 110 may direct the laser towards the C2, C3 pupil optics grazing incidence mirror assembly 105 in one embodiment. A laser-produced plasma generates extreme ultraviolet radiation in a vacuum in one embodiment. As another example, a discharge source may be used to produce the EUV radiation.

The radiation from the grazing incidence mirror assembly 105 and condenser C3 may pass through a spectral purity filter 115 on the way to a C5 mirror 120. The C5 mirror 120 is a grazing incidence mirror that reflects the illuminated light to the mask. From the C5 mirror 120 the radiation may pass to a reticle stage 107. The reticle stage 107 includes the mask whose pattern is to be transferred to a wafer. The reticle is also a reflective multilayer coated mask.

From the reticle, the radiation passes through projection optics 113. Then, the radiation enters the wafer stage 107 which actually includes the wafer to receive the pattern.

The projection optic 113 is shown in more detail in FIG. 2 according to one embodiment. The projection optic 113 is the optical system between the mask 111 and the wafer. The mask 111 defines a mask plane. The mask 111 may be part of the reticle stage 107 in FIG. 1.

Radiation from the mask 111 may pass to a first mirror 120d, reflect to a second mirror 120a, pass through a third mirror 120c, and be reflected from a pupil plane mirror 120b in one embodiment. The pupil plane mirror 120b may it include a flare filter 14, to be described in more detail hereinafter. The radiation reflected from the mirror 120b may then be reflected from the mirror 120c, through the mirror 120d, to impact the wafer as indicated. The center line of the optics is indicated at A.

The mirrors 120a, 120b, 120c, and 120d, may be part of a single, multilayer mirror in some embodiments. In other embodiments, other reflective arrangements may be used. For example, in one embodiment, six mirrors may be used in the projection optic 113. While the filter 14 is shown located in the pupil plane, it can be located in the projection optic 113, anywhere between the mask and the wafer, depending on the optical design.

Radiation conveying the information recorded in the gratings in the mask 111 may have diffracted orders including the zero^{th} ±1^{th} and ±2^{th}, etc. orders. The mask 111 may be a binary mask with 1:1 lines and space in a single pitch, as one example.

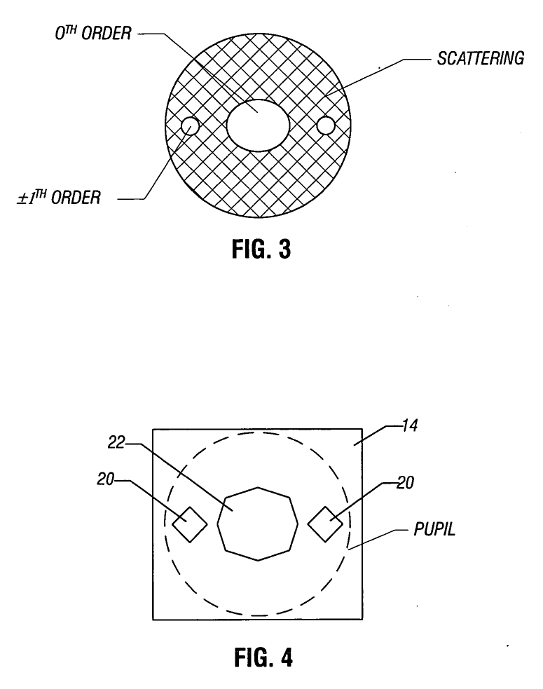

Referring to FIG. 3, an image of the unfiltered pupil view shows scattering as indicated by cross-hatching. The zero^{th} order image is indicated, as are the ±1^{th} orders as indicated in this simple example for 1:1 lines and space mask patterns.

The flare filter 14, shown in FIG. 4, is placed at the pupil plane. The filter 14 has openings 20 designed to transmit the zero^{th} and ±1^{th} orders and blocking the rest of pupil area. The pupil is indicated.

In an extreme ultraviolet (EUV) lithography system, the filter 14 may be placed in front of the mirrors, such as the mirror 120b, at the pupil plane as indicated in FIG. 2.

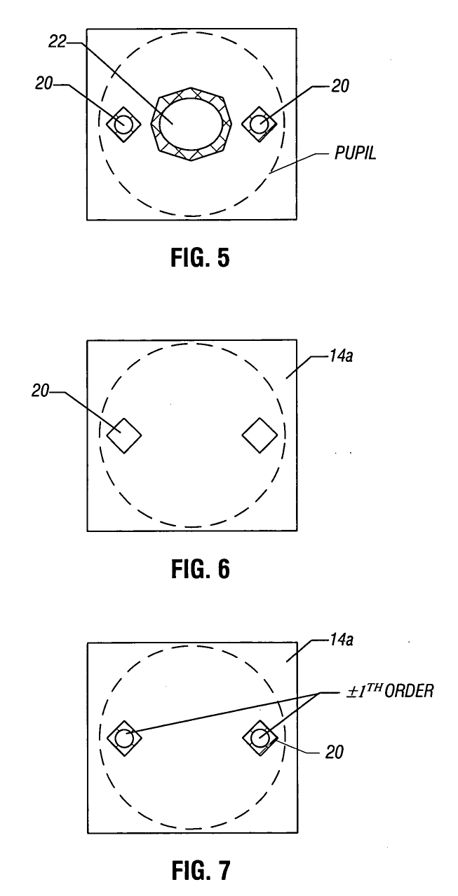

Referring to FIG. 5, the result of the application of the flare filter 14 to the image shown in FIG. 3 is that the amount of flare may be dramatically reduced in some cases. The flare only results from the greater size of the openings 20 and 22, relative to the actual size of the zero^{th} and ±1^{th} orders.

Through the use of a spatial filter 14 at the projection optics exit pupil plane, the effect of extreme ultraviolet flare may be reduced. This technique does not need the use of special mask features to reduce extreme ultraviolet flare. By putting the spatial filter in the exit pupil plane, the amount of flare can be reduced or even minimized. This relaxes the requirements for multilayer mirror polishing in mid spatial frequency ranges.

The information needed for defining the flare reduction filter is the diffraction patterns from the mask. The diffraction patterns from the mask can be calculated if the mask contents are well known. With the information of the mask diffraction patterns, one can create a filter to block the background scattering at the pupil plane. Lithography friendly mask designs for critical layers are becoming more popular for 65 nanometer node and beyond. The mask design usually has unidirectional features with a lower number of pitches. This makes it easy to predict the diffraction patterns at the pupil plane. If the diffraction patterns are known, designing a filter to reduce the extreme ultraviolet flare is feasible. Since extreme ultraviolet lithography systems require from six to eight mirrors, installing the filter in the pupil plane may be advantageously implemented when the system is defined.

The flare filter may be a simple and inexpensive device where the pupil plane can be accessible like a simple mask through automated filter exchanger. The pupil filter blocks the appropriate areas in the pupil plane that are not used for imaging. For very complex mask structures and orientations, the flare filter may be less useful.

If the flare of a given system and mask is F, then the amount of flare with a flare blocking filter is F times the transmitting area of the filter, divided by the area of the pupil. This can be on the order of 0.2 or even smaller depending on the illumination condition.

As another application of the flare filter, referring to FIG. 6, a filter 14a may block the zero^{th} order of light to create a frequency doubling effect for extreme ultraviolet light as indicated in FIG. 7. This increases the patterning capability of the extreme ultraviolet lithography system without using phase shifting masks or other illumination tricks or double patterning tricks. Thus, in FIG. 6, the mask blocks the 0^{th} order and passes the ±1^{th} order. This provides a frequency doubling effect.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
generating extreme ultraviolet radiation; and
using a filter to filter flare from said extreme ultraviolet radiation.

2. The method of claim 1 including locating said filter within projection optics of an extreme ultraviolet lithography apparatus.

3. The method of claim 2 including using a flare filter located at the pupil plane.

4. The method of claim 1 including providing a filter with openings corresponding to a ±1^{th} order.

5. The method of claim 4 including providing a filter with an opening corresponding to the 0^{th} order.

6. A lithography system comprising:
projection optics; and
a flare filter in the projection optics to filter flare.

7. The system of claim 5 wherein said system is an extreme ultraviolet lithography system.

8. The system of claim 6 including a multilayer mirror in said projection optics.

9. The system of claim 6 wherein said flare filter is positioned at the pupil plane.

10. The system of claim 6, said filter to filter all but the 0^{th} and ±1^{th} orders.

11. The system of claim 6 wherein said filter to filter out the 0^{th} order and to pass the ±1^{th} order.

12. The system of claim 6 wherein said system is an engineering test system.

13. The system of claim 6 including a radiation source, a mask holder, and a wafer holder.

14. A frequency doubler comprising:
a radiation source; and
a filter to pass the ±1^{th} order from said source while blocking said 0^{th} order from said source.

15. The doubler of claim 14 wherein said doubler is at the pupil plane.

16. The doubler of claim 14 wherein said doubler substantially blocks all orders but the ×1^{th} order.

17. The doubler of claim 14 including a projection optics, said filter within said projection optics.

18. The doubler of claim 17, said projection optics including a mirror, said filter associated with said mirror.
